(19) United States
(12) Patent Application Publication
(10) Pub. No.: US 2017/0203724 A1
(43) Pub. Date: Jul. 20, 2017

(54) WINDOW WIPER PLATE, ESPECIALLY FOR MOTOR VEHICLES

(71) Applicant: Valeo Systèmes d'Essuyage, Le Mesnil Saint Denis (FR)

(72) Inventors: Philippe Picot, Les Pradeaux (FR); Loic Roussel, Isserteaux (FR)

(73) Assignee: Valeo Systèmes d'Essuyage, Le Mesnil Saint Denis (FR)

(21) Appl. No.: 15/326,283

(22) PCT Filed: Jul. 2, 2015
(86) PCT No.: PCT/EP2015/065081

§ 371 Date: Jan. 13, 2017

(30) Foreign Application Priority Data
Jul. 15, 2014 (FR) 1456765

(51) Int. Cl. B60S 1/34

(52) U.S. Cl. CPC B60S 1/3493; B60S 1/3443; B60S 1/349

(57) ABSTRACT

The invention relates to a bearing of a window wiper system (7) comprising a tube (9) for bearing a winder wiper blade driving shaft (11), the tube (9) having a protuberance (15) for cooperating with a supporting element in the form of a hollow rod (5), characterised in that the protuberance (15) has a collar (25) arranged at a distance from the tube (9).

The present invention relates to a window wiper plate, especially for motor vehicles.

Documents DE-A-2 920 899 and WO 9914086, for example, disclose a window wiper plate constituted by a supporting element in the form of a hollow rod cooperating with at least one window wiper bearing via a protuberance carried by said bearing.

The window wiper bearing may be used as a support for a driving shaft connected to a window wiper device constituted generally of a window wiper arm and a window wiper blade and/or as an element for securing on the bodywork of the motor vehicle.

The end of the supporting element in the form of a hollow rod is connected to the protuberance in a secure manner via any known means, such as riveting or, as described more precisely in the aforesaid application, via insertions of segments of the supporting element in the form of a hollow rod into recesses carried by the protuberance, in such a manner as to produce a non-detachable connection between the bearing and the hollow rod.

However, these different types of connection present a number of drawbacks.

Indeed, the assembly of the hollow rod with the protuberance may be achieved only with a degree of diametral clearance between the two pieces, allowing the sliding of said hollow rod around the protuberance.

In the case of a riveted non-detachable connection, for example, the clearances between the protuberance and the rod persist, creating a gap, arranged as a circle, between the surfaces of the hollow rod and the protuberance. Similarly, during the operation of non-detachable connection via insertion of segments inside the recesses, the supporting element in the form of a hollow rod is deformed at the protuberance, thereby increasing the volume of the gap between the internal wall of the hollow rod and the external wall of the protuberance.

This gap allows the ingress of undesirable impurities, such as water spray, which infiltrate inside the supporting element in the form of a hollow rod and accumulate therein.

This water inside the hollow rod may give rise over time to a phenomenon of oxidation of the hollow rod, possibly leading, in the long term, to the rupture thereof and, in the event of pitching of the vehicle, this water emerges via the gaps and comes into contact with adjacent elements of the bodywork, potentially likewise giving rise to a phenomenon of oxidation of the adjacent parts of the bodywork.

A further problem may arise in the event of this water freezing in the hollow rod, which may also undesirably change the structure thereof, especially during repeated winter freezes and thaws, which may result in detachment of the hollow rod from the protuberance.

With a view to preventing water being able to enter the hollow rod, document FR 2670730 has proposed the provision of a sealing means for the hollow rod relative to the bearing, for example in the form of seals made from elastic material inserted into the hollow rod or surrounding the latter, and also a connection protuberance of the bearing.

However, this solution is expensive and requires a specific seal-mounting operation. Furthermore, in order to be able to guarantee leaktightness over a long period, especially throughout the life of the vehicle, i.e. between 10 and 15 years, the elastic material chosen is expensive and has to be of a superior quality in order not to lose elasticity in the wake of the temperature variations (summer/winter, sun/shade, etc.) to which the seal is exposed, which may likewise give rise to a loss of leaktightness.

The present invention proposes to remedy the abovementioned drawbacks at least in part by providing a window wiper plate of lower cost that makes it possible to prevent water flowing inside the supporting element in the form of a hollow rod.

To that end, a subject matter of the invention is a window wiper system bearing comprising a tube for bearing a window wiper blade driving shaft, the tube having a protuberance for cooperating with a supporting element in the form of a hollow tube, characterized in that the protuberance has a collar arranged at a distance from the tube.

Thus, the collar deflects the course of the water flow and prevents it penetrating into the hollow rod. This solution is easy to implement and very effective, and does not require complex mounting operations.

The window wiper bearing may further comprise one or more of the following features, taken alone or in combination:
the collar may be produced as a single piece with the protuberance, or, alternatively, be an add-on piece around the protuberance;
the collar may, for example, be made from metal or, in accordance with a further aspect, be produced from a plastic or elastic material, especially from elastomer.

Provision may be made for the collar to extend while projecting from the circumference of the protuberance so as to form a water deflector.

Provision may also be made for this collar to have an oblong shape, the major axis of which is included in a plane defined by the axis of the supporting tube and by the axis about which the hollow rod extends substantially symmetrically. In addition, this major axis of the oblong collar may, for example, be parallel to the axis of the supporting tube or perpendicular to the axis of the protuberance.

According to a further series of features, taken alone or in combination, provision may be made for the protuberance to have stiffening ribs, and for:
these ribs to extend on either side of the protuberance along an axis parallel to the axis of the tube;
the collar to be arranged at the level of the stiffening ribs;
the collar to extend while projecting from these stiffening ribs.

When the supporting tube has a cap for cooperating with the linkage pin, the collar is, for example, arranged beyond the offset of the cap relative to the axis of the supporting tube.

A further subject of the invention is a window wiper plate, especially for motor vehicles, comprising a supporting element in the form of a hollow rod and at least one window wiper system bearing comprising, on the one hand, a tube for supporting a window wiper blade driving shaft and, on the other hand, a protuberance for cooperating with a supporting element in the form of a hollow rod, characterized in that the protuberance has a collar arranged at a distance from the tube. In addition, this collar may be arranged at a distance from the tube and at a distance from the free end of the hollow rod via which the hollow rod is arranged around the protuberance. The collar is thus clear of the hollow rod, that is to say not covered by this hollow rod.

Further advantages and features will become apparent on reading the description of the invention, and also from the appended drawings, in which:

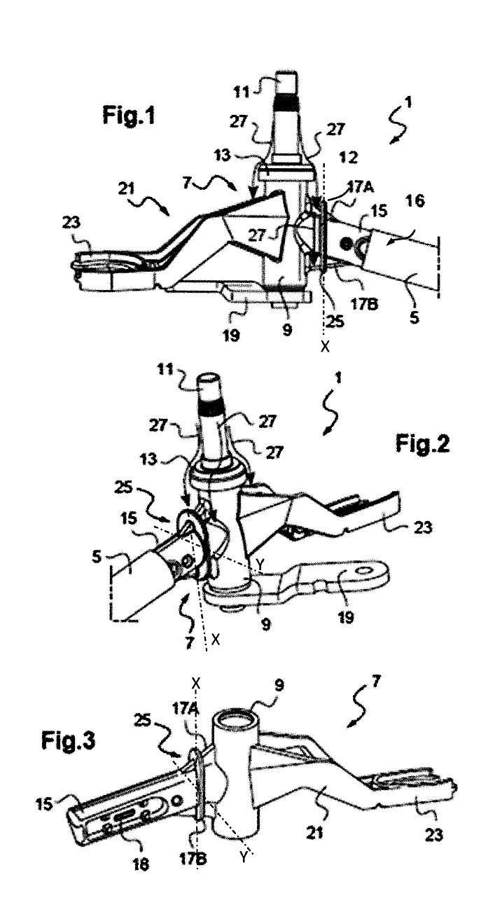

FIG. 1 is a first schematic perspective view of a window wiper plate according to the invention;

FIG. 2 is a second schematic perspective view of the plate of FIG. 1, turned through approximately 160°; and

FIG. 3 is an individual view of a window wiper bearing.

In these figures, identical elements have the same reference numerals.

A description will now be given of an illustrative embodiment of a window wiper plate 1 according to the invention, with reference to FIGS. 1 to 3.

The window wiper plate 1 that can be used, especially, in motor vehicles, comprises a supporting element in the form of a hollow rod 5 and at least one window wiper bearing 7 having a tube 9 supporting a window wiper blade driving shaft 11.

A cap 13 is slipped onto the window wiper blade driving shaft 11 and ensures leaktightness between this shaft 11 and the tube 9.

The cap 13 has a first ring dimensioned in order to surround the driving shaft 11 without clearance, a transverse wall extending the first ring substantially perpendicularly toward the exterior in order to carry a second ring 12 dimensioned in order to surround the tube 9. The cap forms a sealing means that makes it possible to prevent the ingress of water, especially inside the tube 9.

The supporting element, that is to say the hollow rod 5, cooperates with said bearing 7 via a protuberance 15 carried by said bearing 7. The hollow rod 5 is slipped around the protuberance 15 via the free proximal end 16 thereof.

This protuberance 15 is, for example, made as a single piece with the tube 9, for example by molding or, in a variant, in the form of an add-on piece secured to this tube 9 by welding.

The protuberance 15 extends while projecting radially from the tube, over a distance that makes it possible to offer a sufficiently large bearing surface for mounting the hollow rod. The protuberance 15 extends along a principal axis that is inclined relative to the normal to the axis of the tube 9, in such a manner that, in the assembled position of the window wiper plate 1, the protuberance extends substantially downward when the driving shaft 11 projecting from the tube 9 itself extends upward (in accordance with the orientation illustrated in FIG. 1). It will thus be understood that any water on the protuberance tends to flow under gravity toward the free end of the protuberance 15 and thus toward the hollow rod 5.

The join between the protuberance and the tube 9 is reinforced by the presence of stiffening ribs 17A and 17B, which each have the form of a substantially triangular brace, connecting the tube 9 to the protuberance 15. These ribs are arranged on either side of the protuberance in the axial direction parallel to the axis of the tube. Arbitrarily, an upper rib 17A and a lower rib 17B may be identified in the orientation illustrated in FIG. 1.

As may be seen more easily in FIG. 3, the protuberance 15 has, at the level of its free end, a securing zone 18 configured in order to contribute to the fixing of the hollow rod. In the example illustrated, the securing zone has crimping marks. The securing zone 18 is designed to be covered by the hollow rod 5 when this is slipped onto the protuberance prior to the securing thereof. In the case illustrated, a crimping force is applied, using tooling of suitable shape, for example complementing the shape of the marks in the securing zone 18, thereby securing the hollow rod 5 around the protuberance 15.

The window wiper blade driving shaft 11 is connected at its lower end (seen in the figures) to a crank 19 designed to be connected to a window wiper driving mechanism (not shown).

A supporting plate 21, which terminates, at its free end, in a securing flange 23, is affixed opposite the protuberance 15, enabling the bearing 7 to be secured, for example, onto an element of the bodywork of the motor vehicle.

In order to prevent water flowing into the hollow rod 5, the protuberance 15 has a water deflector in the form of a collar 25. In order to act as a stop to prevent the passage of water toward the hollow rod, this collar extends while projecting radially from the circumference of the protuberance.

“Collar” will be understood to mean a zone where there is a substantial increase in the mean dimension of the protuberance 15, such that the water arriving from the driving shaft and flowing along the tube can be halted by the collar 25 and cleared away sideways at a distance from the protuberance in order not to penetrate the hollow rod downstream.

The collar 25 is arranged on the protuberance at a distance from the tube 9 and, more particularly, between the tube 9 and the securing zone 18 configured in order to contribute to the securing of the hollow rod 5. Thus, when the hollow rod 5 is assembled on the protuberance 15, the collar extends between the tube and the proximal end 16 of the hollow rod 5, the securing zone 18 being covered by the hollow rod. The collar is thus clear of the hollow rod, that is to say, in other words, the collar is not covered by the hollow rod such that it forms a means for halting the flow of water upstream of the hollow rod and thus no liquid flowing from the tube 9 along the protuberance penetrates the hollow rod and stagnates therein.

The collar has the form of a plate arranged across the principal axis of the protuberance 15. In the example illustrated, the collar 25 extends in a plane substantially parallel to the axis of the tube 9, but it will be understood that it could extend in a plane substantially perpendicular to the principal axis of the protuberance 15, provided the function of blocking off the water flowing along the protuberance is properly performed. The orientation of the collar 25 relative to the axes of the tube 9 and of the protuberance 15 may, especially, be chosen as a function of the distance to which the collar extends from the tube and thus as a function of the direction of arrival of water in contact with the collar.

As may be seen in the figures, this collar 25 is produced as a single piece with the protuberance 15, for example as a thickness of a few mm, such as 2 mm.

According to a variant (not shown), the collar 25 is an add-on piece of suitable shape, which has, for example, an opening of a shape complementing the cross section of the protuberance 15 in order to be slipped onto the latter and to be secured thereto, for example by forcible sleeving.

According to the embodiment shown in the figures, the collar 25 is made from metal.

In a variant, it is possible to envisage producing the collar, for example, from a plastic material or an elastic material, especially from elastomer, for example by overmolding, or if the collar 25 is an add-on piece by inserting it onto the protuberance 15.

As may be seen from the figures, the collar 25 has an oblong shape. The major axis X of this oblong shape is defined as the greatest segment joining the two most opposite points of the oblong shape, passing via the center. In addition, the minor axis Y of this oblong shape is defined by the segment connecting two points of the oblong shape and passing via the center, perpendicularly to the major axis.

The oblong collar 25 is oriented such that the major axis X of this collar is included in a plane defined by the axis of the tube 9 and by the axis of the hollow rod 5, whether the collar is perpendicular to the protuberance or, alternatively, inclined in order to be parallel to the axis of the tube.

An orientation of this type makes it possible to increase the dimension of the deflector over the zones where a maximum amount of water is likely to flow along the protuberance, especially above the protuberance in the orientation illustrated in FIG. 1, in such a manner as thereby to increase the water-retention function in order to prevent the latter from penetrating the hollow rod and without thereby increasing the sideways volume of the protuberance.

Just as it was possible to specify above, it will be understood that the collar 25 must extend around the protuberance 15, between the tube 9 and the free proximal end 16 of the hollow rod 5, in order to form a deflector for the water flowing along the tube and the protuberance and to prevent said water from penetrating the hollow rod.

In an advantageous embodiment, the position of the collar 25 is more particularly envisaged beyond the offset of the cap 13 relative to the axis of the tube 9. This position of the collar is advantageous in order to prevent water infiltrating between the deflector and the supporting rod, as will be described below.

FIGS. 1 and 2 show, by arrows 27, the flow of water downward along the window wiper blade driving shaft 11, and it can be seen that the collar 25 is a simple, effective and inexpensive means for preventing water from flowing along the protuberance 15 and thus penetrating the hollow rod 5.

The collar is advantageously placed at a distance from the wall of the tube 9, beyond the offset of the cap 13, that is to say beyond the projection on the protuberance of the second ring 12 of the cap, along the axis of the tube 9, in such a manner as to make it possible to block off all the water that is sprayed radially toward the exterior of the tube via the diameter of the second ring. The water deflected (visible in the form of the arrows 27) by the second ring 12 of the cap 13 encounters the protuberance 15 upstream of the collar 25.

Furthermore, the position of the collar is more particularly envisaged such that it extends while projecting from the protuberance at the level of the stiffening ribs 17A and 17B, bearing on the latter.

This arrangement is especially interesting in terms of the manufacturing method, since the injection of material for forming the collar is facilitated. In this zone of the mold, material is already injected in order to form the ribs and the injected material must thus spread less deeply into the groove of the mold corresponding to the formation of the collar. This arrangement is, in fact, more advantageous economically and in terms of weight, since less injection material is required. Furthermore, in terms of mechanical behavior, the projecting portion of the collar is stiffened by the presence of the ribs.

This arrangement is also advantageous when the collar is produced as an add-on piece, since affixing of the collar onto the rib, for example by providing a transverse notch into which the piece forming the collar is accommodated, is made easier than on the cylindrical circumference of the protuberance.

1. A window wiper system bearing comprising:
a tube for bearing a window wiper blade driving shaft, the tube having a protuberance for cooperating with a supporting element in the form of a hollow rod, wherein the protuberance has a collar arranged at a distance from the tube.

2. The window wiper system bearing as claimed in claim 1, wherein the collar is arranged between the tube and a securing zone configured to be covered by the hollow rod.

3. The window wiper system bearing as claimed in claim 2, wherein the securing zone extends in the vicinity of the free end of the protuberance, opposite the tube.

4. The window wiper system bearing as claimed in claim 1, wherein the collar is produced as a single piece with the protuberance.

5. The window wiper system bearing as claimed in claim 1, wherein the collar is an add-on piece.

6. The window wiper system bearing as claimed in claim 1, wherein the collar is made from metal.

7. The window wiper system bearing as claimed in claim 1, wherein the collar is made from elastomer.

8. The window wiper system bearing as claimed in claim 1, wherein the collar extends while projecting from the circumference of the protuberance in order to form a water deflector.

9. The window wiper system bearing as claimed in claim 1, wherein the collar has an oblong shape.

10. The window wiper system bearing as claimed in claim 9, wherein the major axis of the collar is included within the plane defined by the axis of the tube and by the axis around which the hollow rod extends.

11. The window wiper system bearing as claimed in claim 9, wherein the major axis of the collar is parallel to the axis of the supporting tube or perpendicular to the axis of the protuberance.

12. The window wiper system bearing as claimed in claim 1, wherein the protuberance has stiffening ribs.

13. The window wiper system bearing as claimed in claim 12, wherein the stiffening ribs extend on either side of the protuberance along an axis parallel to the axis of the tube.

14. The window wiper system bearing as claimed in claim 12, wherein the collar is arranged at the level of the stiffening ribs.

15. The window wiper system bearing as claimed in claim 14, wherein the collar extends while projecting from the stiffening ribs.

16. The window wiper system bearing as claimed in claim 1, wherein the tube has a cap for cooperating with the window wiper blade driving shaft, said collar being arranged beyond the offset of the cap relative to the axis of the tube.

17. A window wiper plate, especially for motor vehicles, comprising a supporting element in the form of a hollow rod and at least one window wiper system bearing as claimed in claim 1.

18. The window wiper plate as claimed in claim 17, wherein the collar extends around the protuberance between the tube and the hollow rod, said collar being clear of said hollow rod.
